(19) United States
(12) Patent Application Publication
(10) Pub. No.: US 2017/0039643 A1
(43) Pub. Date: Feb. 9, 2017

(54) MULTI-LEVEL POSITION INTERFACE

(71) Applicant: TRADING TECHNOLOGIES INTERNATIONAL INC., Chicago, IL (US)

(72) Inventor: Andre Charles RUSSELL, Glendale Heights, IL (US)

(21) Appl. No.: 14/819,147

(22) Filed: Aug. 5, 2015

(51) Int. Cl. G06Q 40/04

(52) U.S. Cl. CPC G06Q 40/04

(57) ABSTRACT

Market data from one or more electronic exchanges may be analyzed for generating a multi-level position interface that indicates the market position of a user. The market data may be analyzed to generate one or more circular rings for displaying different levels of information related to the market position of the user. The circular rings may include one or more segments that may display different types of information within each ring related to the market position of the user. The segments in each ring may be displayed in a manner that identifies the relative market position of the user for tradeable objects being traded at the one or more electronic exchanges, such that the user may submit trade orders in response to the relative market position indicated by the multi-level position interface.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

The market data may identify information related to tradeable objects for which a user has submitted trade orders to an electronic exchange. Users may access the market data to calculate the user's current market position and determine the user's profit or loss in different markets. When a user is trading multiple tradeable objects at one or more exchanges, the user may have to navigate through several display windows, making it difficult to track the user's market position, particularly as the market data may be updated in each window in real-time as the market data changes. As the user may be unable to efficiently track a current market position, the user may also be unable to promptly act to submit trade orders to optimize or improve the user's position.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of another example electronic trading system in which certain embodiments may be employed.

FIGS. 5A and 5B illustrate example configurations of a user interface that may be displayed on a computing device to provide market position information and enable a user to submit trade orders to an electronic exchange.

FIGS. 6A-6C illustrate other example configurations of a user interface that may be displayed on a computing device to provide market position information and enable a user to submit trade orders to an electronic exchange.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Systems, methods, and apparatus are described for generating a multi-level position interface. The multi-level position interface may be generated based on market data received from one or more exchanges. The market data may include an order book definition. The order book definition may include tradeable objects, a price associated with each tradeable object, and/or a quantity associated with each tradeable object. The multi-level position interface may be generated at a computing device, such as a trading device for example, to identify a market position of the user based on the order book definition.

The market data may be analyzed at the computing device, such as a trading device for example, to assign the tradeable objects to a financial product class and/or a financial product type. A multi-level position interface may generate a display of the tradeable objects assigned to the financial product class and/or the financial product type. For example, the computing device may define a financial product class ring that includes one or more financial product class segments. Each financial product class segment may identify a different financial product class for the tradeable objects. The computing device may also define a financial product type ring that includes one or more financial product type segments. Each financial product type segment may identify a different financial product class for the tradeable objects. The financial product class ring and the financial product type ring may be circular rings that may be displayed to convey different levels of information related to the market position of a user.

The computing device may also define a trade order ring that may include one or more trade order segments. Each trade order segment may identify information for one or more trade orders for a tradeable object at an order book of an electronic exchange. For example, the trade order segments may identify a tradeable object (e.g., contract), order information for the tradeable object, an electronic exchange at which the tradeable object has orders pending at an order book, a current bid price for the tradeable object at the exchange, a current offer price for the tradeable object at the exchange, a current position of the user in the market, a user account for trading on the exchange, or any combination thereof. In certain embodiments, the user account may represent a single user. In other embodiments, the user account may represent a parent or master account and may serve to identify multiple child or otherwise identified sub-account that relate to the parent account.

Each of the segments in the financial product class ring, the financial product type ring, and/or the trade order ring may identify a relative quantity for the segments in each ring when compared with the other segments in the ring. The relative quantity may be indicated by a relative size of the segment. The relative size of each segment in the respective rings may be indicated by a radial width of the segment. A user may identify a relative market position in different financial product classes, financial product types, and/or for different tradeable objects based on the relative size of the segments in each ring.

The multi-level position interface may include an order entry hub. The order entry hub may be used to receive order parameters at a computing device for submitting a trade order to one or more electronic exchanges. The order entry hub may be included within the circular rings of the multi-position interface, or may be displayed outside of the circular rings. The order entry hub may be updated based on user selections of different segments in the multi-level position interface.

A user may provide an input selection to the computing device that may identify one of the segments in the circular rings displayed in the multi-level position interface. The computing device may identify the input selection and determine a user selection of a segment based on the input selection. The computing device may update the order entry hub to identify a price and/or quantity associated with the selected segment. The price may be an average price for the quantity of tradeable objects represented by the segment corresponding to the input selection.

The computing device may send a trade order to at least one electronic exchange that includes an order quantity that is equal to the quantity of the tradeable objects represented by the segment corresponding to the input selection. The transmission of a trade order that has the order quantity of the tradeable objects represented by a given segment may allow a user to exit an exchange for a selected tradeable object, financial product type, and/or financial product class.

The embodiments described herein may be performed by an interface manager that may be located at one or more computing devices. For example, the interface manager may be a software and/or hardware module that may reside at a trading device as described herein.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Systems, methods, and apparatus are described for generating a multi-level position interface. As described herein, an order book definition may be received at a computing device. The order book definition may include a plurality of tradeable objects, a price associated with each tradeable object, and/or a quantity associated with each tradeable object. The computing device may analyze the received order book definition by assigning each of the plurality of tradeable objects to a financial product class and/or assigning each of the plurality of tradeable objects to a financial product type. The computing device may generating a multi-level position interface. The multi-level position interface may include an order entry hub.

The computing device may define a financial product class ring. The financial product class ring may encompass the order entry hub. The computing device may define a financial product type ring. The financial product type ring may encompass the financial product class ring. The computing device may generate at least one financial product class segment in the financial product class ring. The at least one financial product class segment may correspond to a financial product class of one of the plurality of tradeable objects. A radial width of the at least one financial product class segment may correspond to the quantity of the tradeable objects assigned to the financial product class. The quantity of the tradeable objects may comprise an absolute value of the quantity of a user position in a market for the financial product class.

The computing device may generate at least one financial product type segment in the financial product type ring. The at least one financial product type segment may correspond to the financial product type and the financial product class of one of the plurality of tradeable objects. A radial width of the at least one financial product type segment corresponds to the quantity of the tradeable objects assigned to the financial product type. The quantity of the tradeable objects may comprise an absolute value of the quantity of a user position in a market for the financial product type.

The computing device may also, or alternatively, define a trade order ring. The trade order ring may encompass the financial product type ring. The computing device may generate at least one trade order segment in the trade order ring that corresponds to a tradeable object of the plurality of tradeable objects that has a financial product type and a financial product class. A radial width of the at least one trade order segment may correspond to the quantity of the tradeable object in an order book for a user. The quantity of the tradeable objects may comprise an absolute value of the quantity of a user position in a market. The computing device may receive an input selection for one of the at least one trade order segments.

The computing device may receive an input selection corresponding to one of the generated segments and may determine an average price for the quantity of the tradeable objects represented by the radial width of the segment corresponding to the input selection. The computing device may generate an update for the order entry hub based on the input selection. For example, the update may include the determined average price and the quantity of the tradeable objects represented by the radial width of the segment corresponding to the input selection. The input selection may be received for one of the at least one financial product class segments or one of the at least one financial product type segments.

The computing device may send at least one trade order to an electronic exchange. The at least one trade order may comprise an order quantity that is equal to the quantity of the tradeable objects represented by the radial width of the segment corresponding to the input selection.

The computing device may receive market data related to a plurality of tradeable objects offered at one or more electronic exchanges. The market data may indicates a market position of a user for each tradeable object of the plurality of tradeable objects. The computing device may determine the market position of the user for each tradeable object of the plurality of tradeable objects. The computing device may identifying an order quantity associated the market position of the user for different financial product classes and different financial product types related to the plurality of tradeable objects. The computing device may display a first level of the multi-level position interface that indicates the order quantity associated with the market position of the user for the different financial product classes. The first level may include a plurality of financial product class segments that each correspond to a financial product class. The order quantity for each financial product class may be indicated by a relative size of the financial product class segment that corresponds to the financial product class. The relative size for each financial product class segment may be indicated by a radial width of the financial product type segment.

The computing device may display a second level of the multi-level position interface that indicates the order quantity associated with the market position of the user for the different financial product types. The second level may include a plurality of financial product type segments that each correspond to a financial product type. The order quantity for each financial product type may be indicated by a relative size of the financial product type segment that corresponds to the financial product type. The relative size for each financial product type segment may be indicated by a radial width of the financial product type segment.

The first level may be displayed as a financial product class ring that includes the plurality of financial product class segments. The second level may be displayed as a financial product type ring that includes the plurality of financial product type segments. The financial product class ring may be encompassed by the financial product type ring, but the circular rings may be displayed in any order.

The computing device may generate an order entry hub. The order entry hub may be configured for receiving order parameters via an input selection for generating trade orders to be submitted to one or more electronic exchanges. The order entry hub may be displayed at the computing device. The financial product class ring may encompass the order entry hub.

The computing device may receive an input selection corresponding to one of the displayed segments. The computing device may generate a trade order ring comprising at least one trade order segment in response to the input selection. The at least one trade order segment may correspond to a tradeable object of the plurality of tradeable objects that has a financial product type and a financial product class indicated by the input selection. A radial width of the at least one trade order segment may correspond to the quantity of the tradeable object in an order book for a user. The computing device may display the trade order ring in response to the input selection.

Though the embodiments described herein may be described as being performed by one or more computing devices, or software and/or hardware processes that may be executing on one or more computing devices, one or more portions of the embodiments may be performed on one or more computing devices. For example, the embodiments described herein may be performed on a trading device, which may include a trading terminal and/or a trading server.

### II. Example Electronic Trading System

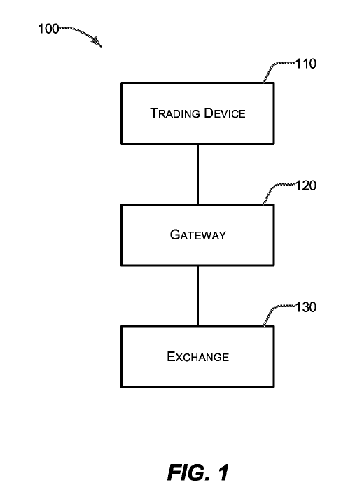

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

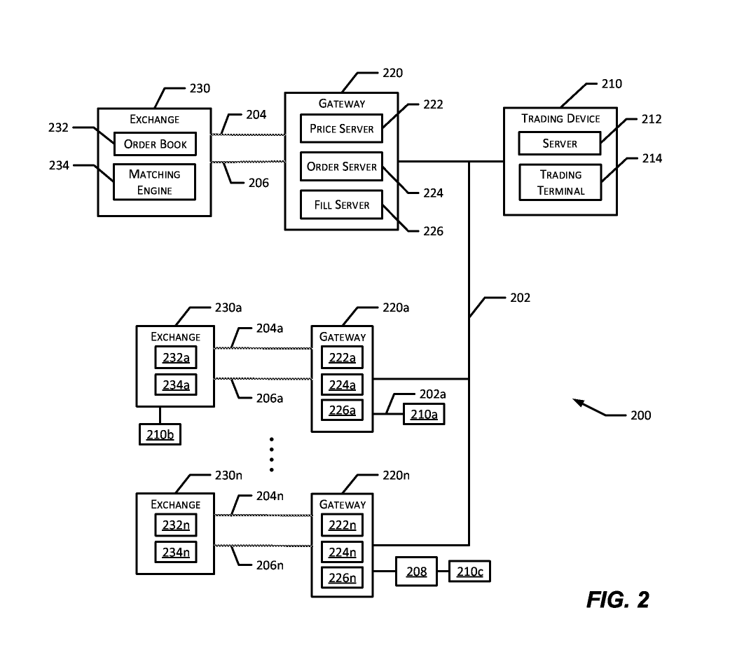

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a230n.

For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

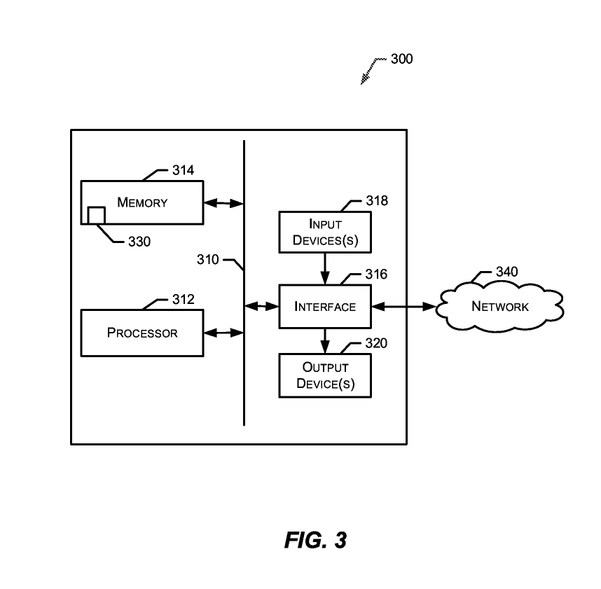

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Multi-Level Position Interface

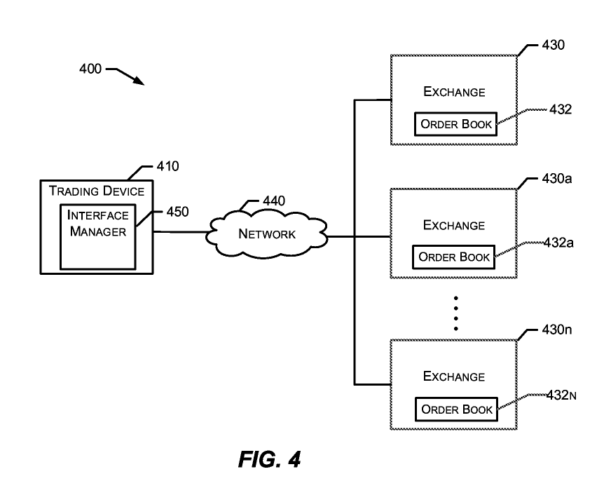

FIG. 4 illustrates a block diagram of an example system 400 that may be used to display order book information for one or more tradeable objects at one or more electronic exchanges. The system 400 may include a trading device 410 that may receive market data from one or more exchanges, such as exchange 430 and/or exchanges 430a to 430n. The trading device 410 may communicate with the exchanges directly or through a network 440. The market data from the exchanges 430 to 430n may correspond to one or more tradeable objects at each market.

The market data may include an order book definition from one or more order books, such as order book 432 and/or order books 432a to 432n. Each of the order books 432 to 432n may include data relating to unmatched trade orders that have been submitted to respective exchanges 430 to 430n. The order book definition may include tradeable objects, a user or trading device that submitted a trade order for the tradeable objects, an exchange 430 to 430n at which the tradeable objects may be exchanged, an order price for each tradeable object, an order quantity for each tradeable object, and/or other market data related to unmatched trade orders that have been submitted to respective exchanges 430 to 430n. The order book definition may be received in response to a query from the trading device 410 or in an update message received periodically from the exchanges 430 to 430n.

The market data may also include information related to available bids and available offers for identified tradeable objects at the exchanges 430 to 430n. The information related to the available bids and available offers may identify available contra-side order quantities and order prices available for being matched at the exchanges 430 to 430n. The market data may be received in response to a query from the trading device 410 or in an update message received periodically from the exchanges 430 to 430n. The market data, including the order book definition for example, may be received in an update message in real-time upon an update to the order book information associated with the user of the trading device 410 and/or the trading device 410 itself. For example, the market data may be received at the trading device 410 in response to an order being filled at one or more of the order books 432 to 432n.

The order book definition may be related to a particular user of the trading device 410 or the trading device 410 itself from which trade orders may be submitted. For example, the order book definition may include market data relating to unmatched trade orders submitted by a particular user of the trading device 410 or the trading device 410 itself to respective exchanges 430 to 430n. The information in the order book definition may also, or alternatively, be stored at the trading device 410 when trade orders are submitted from the trading device 410 to the exchanges 430 to 430n. The trading device 410 may store the order book definition locally, at a remote device, or the order book definition may be distributed across multiple devices. For example, the trading device 410 may include a trading terminal and a trading server at which the order book definition may be stored upon being sent to an order book.

The trading device 410 may be capable of displaying a user interface that may indicate information related to a user's position in one or more markets as described herein. As described above, the trading device 410 may be a trading server and/or a trading terminal. The functionality described herein may be performed on the trading terminal, the trading server, or may be distributed across the trading terminal and the trading server. For example, the trading device 410 may include a trading terminal capable of displaying a user interface for an application executing locally on the trading terminal or an application executing remotely on the trading server and accessed on an application at the trading terminal (e.g., via a web browser or other application).

The trading device 410 may include an interface manager 450, which may be executed locally at the trading terminal, at the trading server, or distributed across the trading terminal and the trading server. The interface manager 450 may perform analysis for generating a user interface that indicates the market position of one or more users. For example, the interface manager may receive an order book definition and/or other market data, analyze the order book definition and/or other market data, make calculations for generating a user interface, and/or generate the user interface in a configuration that indicates the market position of one or more users.

The interface manager 450 may analyze the order book definition to assign each of the plurality of tradeable objects to a financial product class and/or a financial product type. The financial product class may include a class of financial products having different financial product types. For example, financial product classes may include commodities, bonds, options, energies, treasures, currencies, indices, and/or the like. Financial product types may include different types of tradeable objects that may be traded on an exchange. For example, the financial product types may include different types of contracts that may be traded on one or more of the exchanges 430 to 430n. Financial product types may be identified by name, trading symbol, and/or other descriptive indicator. For example, the financial product types within the commodities class may include corn, coffee, sugar, wheat, cotton, and/or the like.

The financial product class and/or financial product type may be indicated in the market data received at the interface manager 450. For example, the interface manager 450 may receive an order book definition that includes a number of different contracts and the interface manager 450 may identify a financial product type and/or a financial product class for each of the contracts. The financial product type and/or the financial product class may be identified from a database that indicates a relationship between financial product classes, financial product types, and tradeable objects.

The interface manager 450 may generate a multi-level interface that indicates the market position of one or more users according to the order book definition. The interface manager 450 may define different rings of the multi-level interface based on market data. Each ring may be defined to include different segments that identify different types of information related to trade orders of a user that are pending at an order book. The multi-level interface may include different levels of detail related to a user's market position in one or more markets. The interface manager 450 may be executed as software and/or hardware. For example, the interface manager 450 may be a software module included in a trading application that is executed by a processor from memory at the trading device 410, or an independent hardware module. The interface manager 450 may generate user interfaces for displaying a market position of one or more users at the trading device 410.

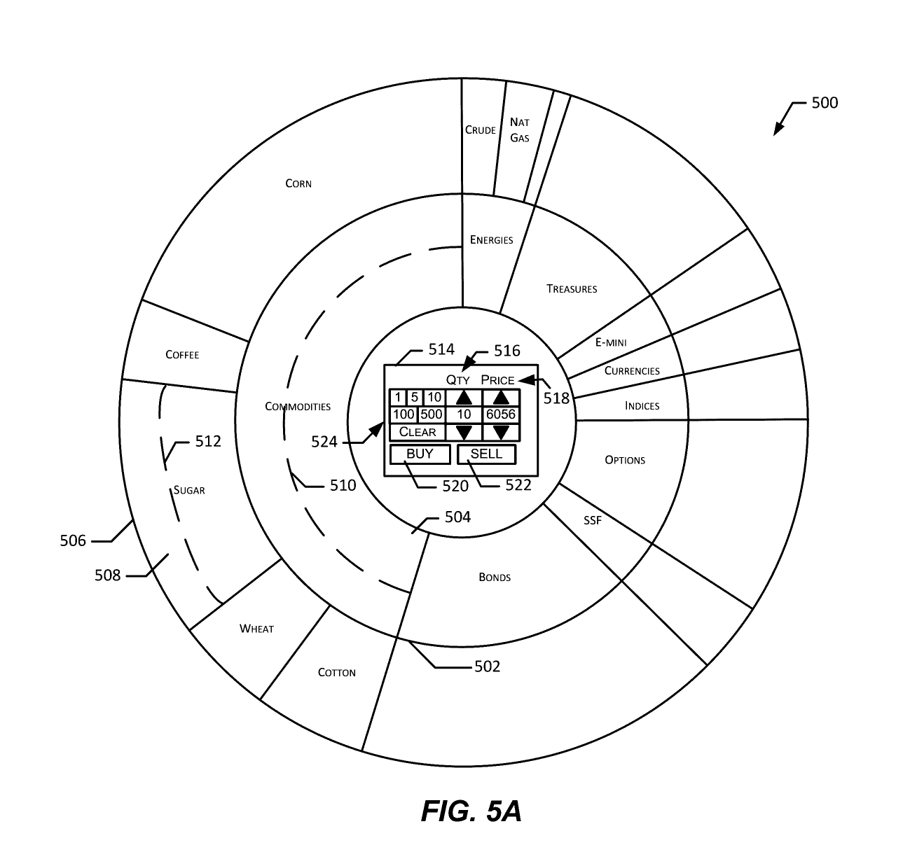

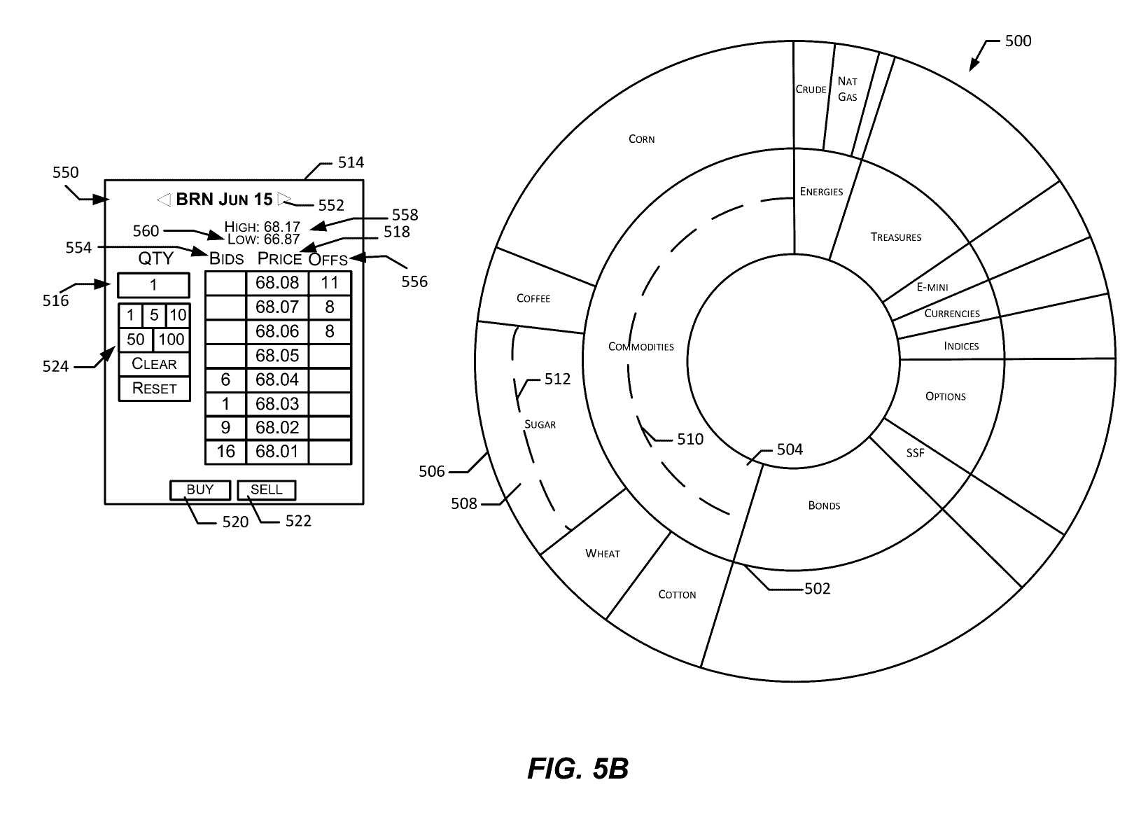

FIGS. 5A and 5B illustrate examples of a multi-level position interface 500 that may be displayed on a computing device to identify a market position of a user for a plurality of tradeable objects. As shown in FIG. 5A, the interface 500 may include a multiple concentric rings that may each identify different levels of information related to a market position for a user. The outside ring may encompass one or more rings that include additional levels of information. The levels of information may become incrementally more detailed in each ring from the exterior ring to the interior ring, or vice versa.

A financial product class ring 502 may be a circular ring that identifies one or more financial product class segments 504. Each of the financial product class segments 504 may identify a financial product class for one or more tradeable objects of a user or a trading device that have been submitted to an order book of an electronic exchange. For example, the financial product class segments 504 may identify classes of financial products, such as bonds, commodities, energies, treasures, E-minis, currencies, indices, options, single-stock futures (SSF), and/or other financial product classes that may identify financial product types that may be traded at an electronic exchange. A financial product type ring 506 may be a circular ring that identifies one or more financial product type segments 508. Each of the financial product type segments 508 may identify a financial product type for one or more tradeable objects (e.g., financial contracts) of a user or a trading device of a user that have been submitted to an order book of an electronic exchange. The financial product type segments 508 may identify a financial product type by name, trading symbol, and/or other descriptive indicator. The financial product types may identify types of tradeable objects (e.g., contracts) that may be traded on an electronic exchange.

Each of the financial product class segments 504 may be displayed having a relative size that may indicate the quantity of the tradeable objects assigned to the financial product class that are pending in the order book. The relative size may be indicated by a radial width 510. To determine the radial width 510 of each financial product class segment 504, a computing device may calculate the order quantity pending in the order book for each financial product class identified by the financial product class segments 504. The order quantity may be the total order quantity pending for a user at the order book or the relative order quantity that a user may be long or short in a market. As the order quantity for a financial product class segment 504 increases or decreases, the radial width 510 of the financial product class segment 504 may increase or decrease, respectively. The computing device may display each financial product class segment 504 with a radial width 510 that corresponds to the relative percentage of the quantity for the financial product class out of the entire quantity for the financial product classes being displayed in the interface 500.

Each of the financial product type segments 508 may be displayed having a relative size that may indicate the quantity of the tradeable objects assigned to the financial product type that are pending in the order book. The relative size may be indicated by a radial width 512. To determine the radial width 512 of each financial product type segment 508, a computing device may calculate the order quantity pending in the order book for each financial product type identified by the financial product type segments 508. The order quantity may be the total order quantity pending for a user at the order book or the relative order quantity that a user may be long or short in a market. As the order quantity for a financial product type segment 508 increases or decreases, the radial width 512 of the financial product type segment 508 may increase or decrease, respectively. The computing device may display each financial product type segment 508 with a radial width 512 that corresponds to the relative percentage of the quantity for the financial product type out of the entire quantity for the financial product types being displayed in the interface 500.

The financial product types identified by the financial product type segments 508 may include subsets of tradeable objects in a financial product class. As shown in the interface 500, the financial product type segments 508 may be aligned with a financial product class segment 504 that identifies the financial product class for which the financial product type segments 508 are a subset. For example, the financial product type segments 508 that include subsets of commodities may be aligned with the financial product class segment 504 identifying commodities. The financial product type segments 508 aligned with the commodities segment may identify financial product types such as corn, coffee, sugar, wheat, and cotton, which may be the commodities for which a user may have trade orders pending at an order book at one or more exchanges. The financial product type segments 508 that are aligned with a financial product class segment 504 may be displayed within the radial width 510 of the financial product class segment 504. The financial product type segments 508 that are subsets of a financial product class segment 504 may be displayed with the same color, pattern, or other identifier.

Though FIG. 5A shows the financial product type ring 506 encompassing the financial product class ring 502, the circular rings may be displayed in any order. The radial width of the segments within each ring may still be aligned to indicate the order quantity for the financial product types within each financial product class when the circular rings are displayed in a different order.

The interface 500 may display an order entry hub 514 that may be used to receive order parameters at a computing device for submitting a trade order to an electronic exchange. The order entry hub 514 may allow a user of a trading device to enter one or more order parameters for a trade order. For example, the order entry hub 514 may allow the user to enter an order quantity 516, an order price 518, and/or an order type for an identified financial product type or a financial product class, which may be identified by a user input selection of one of the financial product type segments 504 or financial product class segments 504, respectively. The order type may be a buy order that may be indicated by the user selecting the buy button 520 or a sell order that may be indicated by the user selecting the sell button 522 in the order entry hub 514. The order entry hub 514 may allow the user to enter predefined order quantities by selecting the predefined quantity buttons 524.

A user may select a financial product type segment 508 to identify a financial product for which the user may submit a trade order to an electronic exchange. The user may set the order parameters for the trade order using the order entry hub 514. The user may select the buy button 520 or the sell button 522 to submit the trade order to the order book at an electronic exchange with the parameters indicated in the order entry hub 514. The computing device may adjust the radial width 512 of the financial product type segment 508 that is assigned to the financial product type submitted in the trade order according to the quantity that is submitted in the trade order. The computing device may also adjust the radial width 510 of the financial product class 504 that is assigned to the tradeable object submitted in the trade order according to the quantity that is submitted in the trade order. If the user has a bid order pending at the order book for a tradeable object, a trade order for a contra-side offer may decrease the radial width 510, 512 for the tradeable object, while another bid order may increase the radial width 510, 512 for the tradeable object. If the user has an offer order pending at the order book for a tradeable object, a trade order for a contra-side bid may decrease the radial width 510, 512 for the tradeable object, while another offer order may increase the radial width 510, 512 for the tradeable object. Though FIG. 5A shows the financial product class ring 502 encompassing the order entry hub 514, any of the circular rings may encompass the order entry hub 514 or the order entry hub 514 may be displayed outside of the circular rings.

FIG. 5B illustrates another example of a display configuration for the multi-level position interface 500. As shown in FIG. 5B, the order entry hub 514 may be displayed outside of the circular rings, or even in a separate interface or display window. The order entry hub 514 may have a different configuration when displayed outside of the circular rings than when displayed inside the circular rings, as the order entry hub 514 may have more space for displaying information. The order entry hub 514 may be extracted from within the circular rings upon user selection (e.g., selection of a button, drag and drop, or other input selection).

The order entry hub 514 may include an identification of a tradeable object 550 for which a trade order may be submitted using the order entry hub 514. The tradeable object 550 may be displayed as a tradeable object within a financial product type of a selected financial product type segment 508 and/or within a financial product class of a selected financial product class segment 504. A user may display information for different tradeable objects within a financial product type and/or a financial product class by selecting one of the buttons 552.

The order entry hub 514 may identify market data for the tradeable object 550. For example, the order entry hub 514 may identify available bids 554 and/or available offers 556 at different order prices 518. The order entry hub 514 may identify the highest available offer 558 and/or the lowest available bid 560. Other market data may also, or alternatively, be displayed in the order entry hub 514. The computing device may display the market data in real-time in response to market updates received from one or more exchanges. The user may select an order price 518 and an order quantity 516 from the order entry hub 514 and may place a trade order at an exchange.

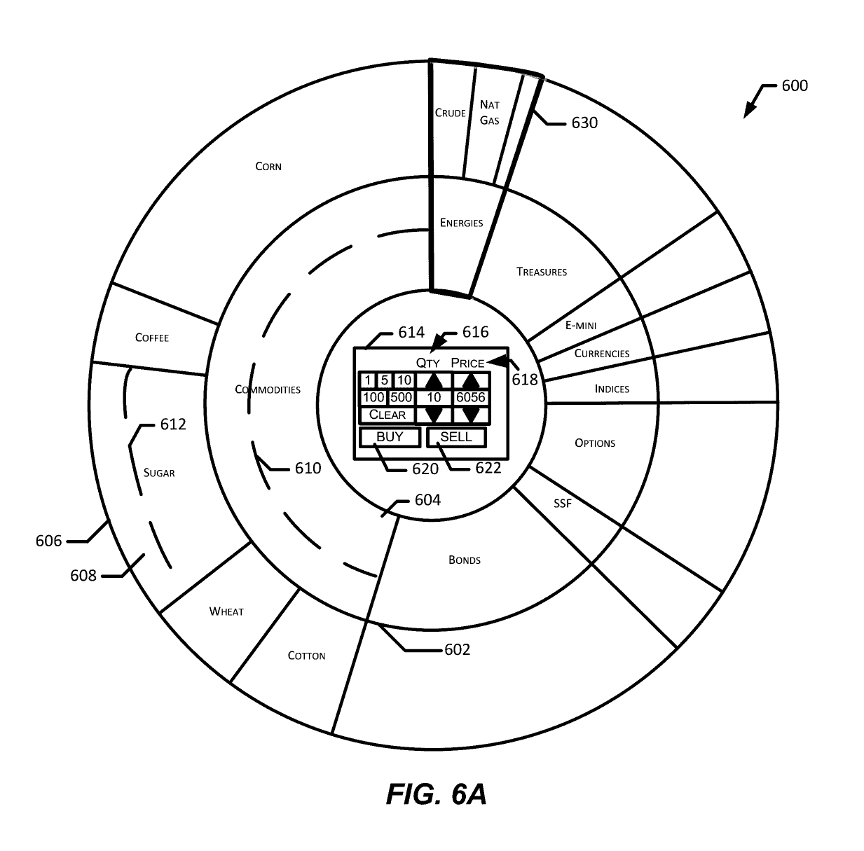

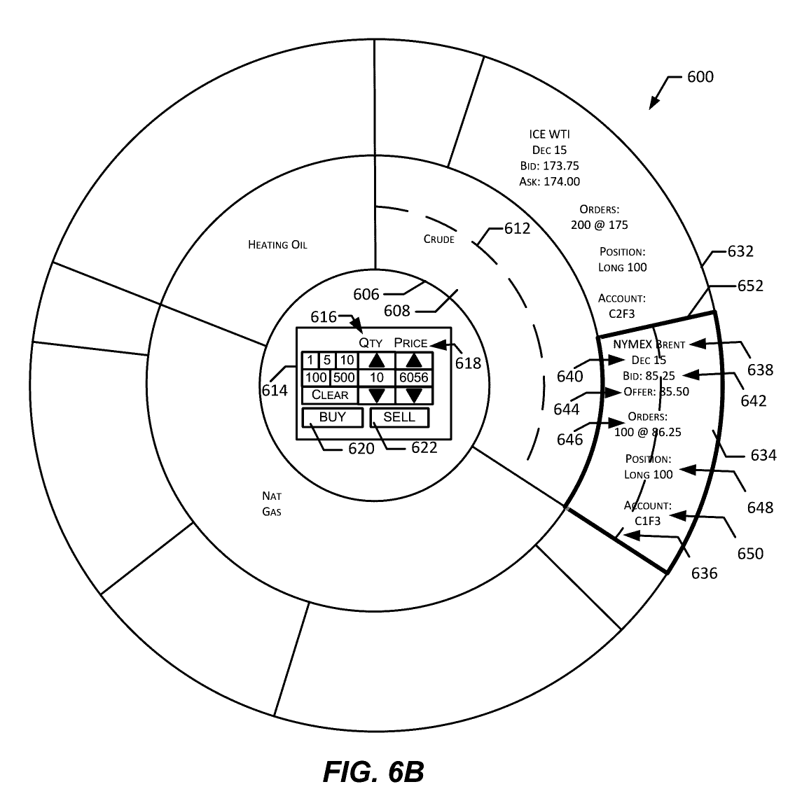

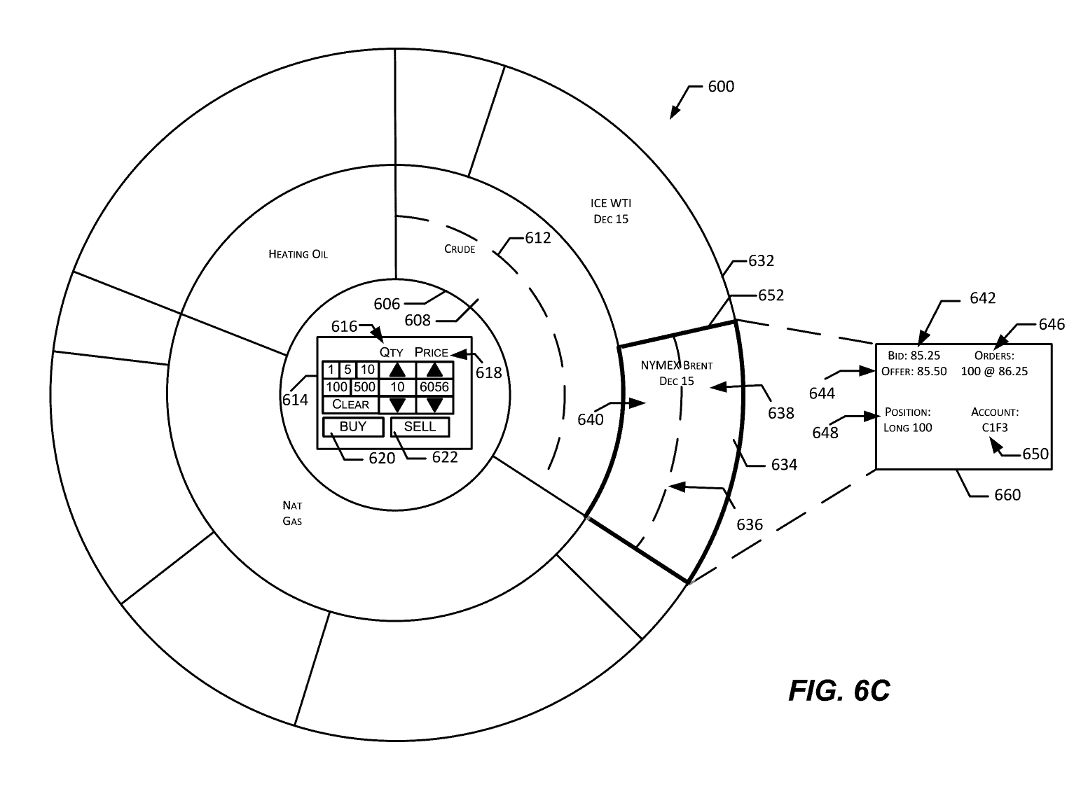

FIGS. 6A-6C illustrate an example of a multi-level position interface 600 that may be displayed on a computing device to identify a market position of a user for a plurality of tradeable objects. A computing device may generate an interface the incorporates portions of the multi-level position interface 500 shown in FIGS. 5A-5B and/or portions of the multi-level position interface 600 shown in FIGS. 6A-6C. As shown in FIG. 6A, the interface 600 may include a number of concentric circular rings that may each identify different levels of a market position for a user. The interface 600 may include a financial product class ring 602 that identifies one or more financial product class segments 604. The interface 600 may include a financial product type ring 606 that identifies one or more financial product type segments 608.

Each of the financial product class segments 604 and the financial product type segments 608 may be displayed having a respective radial width 610, 612 that indicates the quantity of the tradeable objects at an order book that are assigned to the financial product class and the financial product type, respectively. The interface 600 may display an order entry hub 614 that may be used to receive order parameters at a computing device for submitting a trade order to an electronic exchange. The order entry hub 614 may allow a user of a trading device to enter one or more order parameters for a trade order and submit a trade order having the indicated parameters using the buy button 620 or the sell button 622 in the order entry hub 614.

A user may select a financial product class segment 604, or a financial product type segment 608 within a financial product class, to view additional details for the tradeable objects within the financial product class. For example, the user may select the financial product class segment 604 that identifies the energies class or one of the financial product type segments 608 within the energies class to view additional details for the tradeable objects in the energies class. The user interface may highlight the selected class with a class indicator 630 prior to displaying additional details for the tradeable objects within the financial product class. A user may confirm the selection of the highlighted class indicated by the class indicator 630 prior to the interface 600 displaying additional details (e.g., by selection of a confirmation key, by selecting the highlighted financial product class again, or by another form of confirmation), or the interface may automatically proceed to displaying the details for the selected financial product class.

As shown in FIG. 6B, the interface 600 may include different information in each of the circular rings. The interface 600 may be modified to identify additional details of tradeable objects within the financial products class identified by the user in FIG. 6A. For example, the circular rings in the interface 600 may be modified to identify details of tradeable objects within the selected financial products class. The inner circular ring in the interface 600 may be modified to include the financial product type ring 606 that indicates the financial product types within the selected financial product class. The financial product type ring 606 may include the financial product type segments 608. The radial width 612 of each financial product type segments 608 in the financial product type ring 606 may be modified to indicate the relative quantity of the tradeable objects assigned the respective financial product types. For example, each financial product type segments 608 may each be displayed over a greater radial width when the interface 600 displays information for a selected financial product class. Each financial product type segment 608 may be displayed as a percentage of the total quantity of the trade orders pending at an order book for the financial product class.

The outer circular ring in the interface 600 may be modified to include trade order information. For example, the interface 600 may include a trade order ring 632. The trade order ring 632 may be a circular ring that identifies one or more trade order segments 634. Each trade order segment 634 may identify information for one or more trade orders for a tradeable object at an order book of an electronic exchange. For example, the trade order segments 634 may identify a tradeable object 640 (e.g., contract), order information 646 for the tradeable object 640, an electronic exchange 638 at which the tradeable object 640 has orders pending at an order book, a current bid price 642 for the tradeable object 640 at the exchange 638, a current offer price 644 for the tradeable object 640 at the exchange 638, a current position 648 of the user in the market, a user account 650 for trading on the exchange 638, or any combination thereof. When the tradeable object 640 is a contract, the tradeable object 640 may be identified by contract month and/or expiry of the contract.

The current bid price 642 and/or the current offer price 644 may be calculated at the computing device using market data received from the exchange 638. The market data may be received at the computing device in an update message from the exchange 638. The current bid price 642 and/or the current offer price 644 may be updated in the interface 600 in real-time. The current bid price 642 may be the best available bid (best bid) at the exchange 638 for the tradeable object 640. The current offer price 644 may be the best available offer (best offer) at the exchange 638 for the tradeable object 640.

The order information 646 may include an order quantity and/or order price that a user may have pending at an order book for one or more trade orders for the tradeable object 640. The order price may be a representative price for the quantity of the tradeable object 640 that the user has pending in trade orders at the order book of the electronic exchange 638. For example, the computing device may calculate an average price for the quantity of the tradeable object 640 that the user has pending at the order book of the electronic exchange 638 and may display the average price in the order information 646. The current position 648 of the user in the market may indicate whether the order information 646 is for buy orders or sell orders. For example, the current position 648 may indicate whether a user is long or short in the market and/or the quantity of units of the tradeable object 640 that the user may be long or short.

Each of the trade order segments 634 may be displayed having a relative size that may indicate the order quantity of the tradeable object 640 for which one or more trade orders are pending in the order book for the user at the electronic exchange 638. The relative size may be indicated by a radial width 636. As the order quantity for a trade order segment 634 increases or decreases, the radial width 636 of the trade order segment 634 may increase or decrease, respectively. The computing device may display each trade order segment 634 with a radial width 636 that corresponds to the relative percentage of the quantity for the total orders in the financial product class being displayed in the interface 600.

The radial width 636 may correspond to the absolute value of the order quantity indicated by the current position 648 of the user in the market. For example, the computing device may calculate the total quantity value identified in the current position 648 of the user in the market for each of the trade order segments 634 and may use the relative quantity value to calculate the radial width 636 of each trade order segment 634. The long position may be a positive value and the short position may be a negative value, so the computing device may compute the absolute value of the order quantity indicated by the current position 648 of the user in the market. A trade order segment 634 having a long position and a trade order segment 634 having a short position with the same respective order quantity may have the same radial width 636. The trade order segment 634 having a long position and the trade order segment 634 having a short position may be otherwise distinguished in the interface 600, such as by color, pattern, or other identifier. The radial width 610 of the financial product class segments 604 (e.g., shown in FIG. 6A) and the radial width 612 of the financial product type segments 608 may be similarly generated at a computing device according to the user's position in the market. The current position 648, the radial width, and/or the other information indicating the position of the user may allow a user to quickly identify a position and/or profit/loss information in the interface 600.

The trade orders identified by the trade order segments 634 may include subsets of trade orders having a financial product type and/or a financial product class. As shown in the interface 600, the trade order segments 634 may be aligned with a financial product type segment 608 that identifies the financial product type for which the trade order segments 634 are a subset. For example, the trade order segments 634 that include subsets of trade orders for crude oil at an identified exchange may be aligned with the financial product type segment 608 identifying crude oil. The trade order segments 634 aligned with the crude oil segment may identify trade orders for crude oil that are pending at an order book at different exchanges. The trade order segments 634 that are aligned with a financial product type segment 608 may be displayed within the radial width 612 of the financial product type segment 608. The trade order segments 634 that are subsets of a financial product type segment 608 may be displayed with the same color, pattern, or other identifier.

Though the interface 600 in FIG. 6B shows the trade order ring 606 encompassing the financial product type ring 606, the circular rings may be displayed in any order. Additionally, any number of circular rings may be displayed in the interface 600 shown in FIG. 6B. For example, upon user selection of tradeable objects within the financial products class identified by the user in FIG. 6A, the user interface 600 may add the trade order ring 606 to the interface 600. Regardless of the order of the rings, or the number of rings, in the interface 600, the radial width of the segments within each ring may still be aligned to indicate the various subsets for each ring within the radial widths.

As shown in FIG. 6B, the user may select a trade order segment 634 to identify a tradeable object for which the user may submit a trade order to an exchange. The user interface 600 may highlight the selected trade order segment 634 with a trade order indicator 652. The user may set the order parameters for trade order using the order entry hub 614. The user may select the buy button 620 or the sell button 622 to submit the trade order to the order book at the electronic exchange with the parameters indicated in the order entry hub 614. The computing device may adjust the radial width 636 of the trade order segment 634 that corresponds to the tradeable object submitted in the trade order according to the quantity that is submitted in the trade order. The computing device may also adjust the radial width 612 of the financial product type segment 608 (and/or the radial width of the financial product class segment, if displayed) that is assigned to the tradeable object submitted in the trade order according to the quantity that is submitted in the trade order.

The order entry hub 614 may be updated upon selection of a trade order segment 634 to include an order price 618 and an order quantity 616 that may allow a user to completely fill the currently pending orders at the exchange identified by the trade order segment 634. For example, the user may select the trade order segment 634 and the order entry hub 614 may be updated with an order price 618 and an order quantity 616 that matches the order price and the order quantity of the order information 646. The user command for placing an order for a complete fill for a tradeable object may be a unique command (e.g., double click or double tap) that may be recognized by the computing device.

The computing device may place multiple trade orders to get a complete fill on the order quantity identified in the order information 646. As the order price in the order information 646 may identify an average price of the orders pending in an order book at an exchange, the computing device may determine, from the order book information, different orders that may be placed for the same quantity at the same average price in the order information 646, or the orders that may be placed for the same quantity having the closest price to the average price indicated in the order information 646.

The order entry hub 614 may similarly be updated upon selection of a financial product type segment 608 or a financial product class segment 604 (shown in FIG. 6A) to include an order price 618 and an order quantity 616 that may allow a user to completely fill the currently pending orders at one or more exchanges. The order price 618 and the order quantity 618 may indicate the average price of the orders in the selected financial product type segment 608 or the financial product class segment 604. The computing device may generate a trade order for submitting to each exchange that fills the orders for the identified financial product type or financial product class.

A user command may be recognized by the computing device for placing an order for a complete fill for the tradeable objects displayed in the interface 600. For example, the user may double tap or double click the center of the circular rings to indicate a complete fill of the tradeable objects being displayed in the trade order segments 634 or for the tradeable objects in the order book for the financial product type segments 608. The user command, or a separate user command, may be recognized by the computing device for placing an trade orders for a complete fill of the tradeable objects associated with the user, or the trading device of a user, that are pending at an order book at a given exchange or at any exchange. The complete fill may enable a user to match the currently pending trade orders and exit one or more exchanges upon performance of a single command.

FIG. 6C illustrates another example of a display configuration for the multi-level position interface 600 that may be displayed on a computing device. As shown in FIG. 6C, information for a segment within a circular ring may be displayed inside and/or outside of the circular ring. For example, the trade order ring 632 may display trade order segments 634 that may include an identifier of the corresponding trade orders. The identifier may identify the tradeable object 640 and/or the electronic exchange 638 that correspond to the trade order segment 634. Upon user selection of a trade order segment 634, a separate display window 660 may be displayed and/or populated. The display window 660 may identify information for one or more trade orders for the tradeable object 640 at an order book of the electronic exchange 638. For example, the display window 660 may identify order information 646 for the tradeable object 640, the current bid price 642 for the tradeable object 640 at the exchange 638, the current offer price 644 for the tradeable object 640 at the exchange 638, the current position 648 of the user in the market, the user account 650 for trading on the exchange 638, or any combination thereof.

Though FIG. 6C shows the user interface 600 being capable of displaying information for trade order segments 634 in display window 660, similar information may be displayed in the display window 660 upon selection of a segment within any circular ring. For example, a user may perform a selection or command for display of trade order information or other detailed information for financial product type segments 608 or financial product class segments 604 upon user selection.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed:

1. A method of generating a multi-level position interface, the method comprising:
receiving, at an interface manager, an order book definition, wherein the order book definition includes a plurality of tradeable objects, a price associated with each tradeable object, and a quantity associated with each tradeable object;
analyzing, at the interface manager, the received order book definition, wherein analyzing the received order book definition includes:
assigning each of the plurality of tradeable objects to a financial product class; and
assigning each of the plurality of tradeable objects to a financial product type;
generating, at the interface manager, a multi-level position interface including an order entry hub, wherein the generating the multi-level interface further includes:
defining a financial product class ring, wherein the financial product class ring encompasses the order entry hub; and
defining a financial product type ring, wherein the financial product type ring encompasses the financial product class ring;
generating at least one financial product class segment in the financial product class ring, wherein the at least one financial product class segment corresponds to a financial product class of one of the plurality of tradeable objects, and wherein a radial width of the at least one financial product class segment corresponds to the quantity of the tradeable objects assigned to the financial product class;
generating at least one financial product type segment in the financial product type ring, wherein the at least one financial product type segment corresponds to the financial product type and the financial product class of one of the plurality of tradeable objects, and wherein a radial width of the at least one financial product type segment corresponds to the quantity of the tradeable objects assigned to the financial product type;
receiving, at the interface manager, an input selection corresponding to one of the generated segments;
determining, at the interface manager, an average price for the quantity of the tradeable objects represented by the radial width of the segment corresponding to the input selection; and
generating, at the interface manager, an update for the order entry hub, wherein the update includes the determined average price and the quantity of the tradeable objects represented by the radial width of the segment corresponding to the input selection.

2. The method of claim 1, wherein the input selection is received for one of the at least one financial product class segments.

3. The method of claim 1, wherein the input selection is received for one of the at least one financial product type segments.

4. The method of claim 1, further comprising:
defining, at the interface manager, a trade order ring, wherein the trade order ring encompasses the financial product type ring; and
generating at least one trade order segment in the trade order ring, wherein the at least one trade order segment corresponds to a tradeable object of the plurality of tradeable objects that has the financial product type and the financial product class, and wherein a radial width of the at least one trade order segment corresponds to the quantity of the tradeable object in an order book for a user.

5. The method of claim 4, wherein the input selection is received for one of the at least one trade order segments.

6. The method of claim 1, wherein the quantity comprises an absolute value of the quantity of a user position in a market.

7. The method of claim 1, further comprising sending at least one trade order to an electronic exchange, wherein the at least one trade order comprises an order quantity that is equal to the quantity of the tradeable objects represented by the radial width of the segment corresponding to the input selection.

8. A method for generating a multi-level position interface, the method comprising:
receiving, at a trading device, market data related to a plurality of tradeable objects offered at one or more electronic exchanges, wherein the market data indicates a market position of a user for each tradeable object of the plurality of tradeable objects;
determining, at the trading device, the market position of the user for each tradeable object of the plurality of tradeable objects;
identifying, at the trading device, an order quantity associated the market position of the user for different financial product classes and different financial product types related to the plurality of tradeable objects;
displaying, via the trading device, a first level of the multi-level position interface that indicates the order quantity associated with the market position of the user for the different financial product classes, wherein the first level includes a plurality of financial product class segments that each correspond to a financial product class, and wherein the order quantity for each financial product class is indicated by a relative size of the financial product class segment that corresponds to the financial product class; and
displaying, via the trading device, a second level of the multi-level position interface that indicates the order quantity associated with the market position of the user for the different financial product types, wherein the second level includes a plurality of financial product type segments that each correspond to a financial product type, and wherein the order quantity for each financial product type is indicated by a relative size of the financial product type segment that corresponds to the financial product type.

9. The method of claim 8, wherein the first level is displayed as a financial product class ring that includes the plurality of financial product class segments, and wherein the second level is displayed as a financial product type ring that includes the plurality of financial product type segments, and wherein the financial product class ring is encompassed by the financial product type ring.

10. The method of claim 9, further comprising:
generating, via the trading device, an order entry hub, wherein the order entry hub is configured for receiving order parameters via an input selection for generating trade orders to be submitted to at least one of the one or more electronic exchanges; and
displaying, via the trading device, the order entry hub.

11. The method of claim 10, wherein the financial product class ring encompasses the order entry hub.

12. The method of claim 9, further comprising:
receiving, via the trading device, an input selection corresponding to one of the displayed segments;
generating, via the trading device, a trade order ring comprising at least one trade order segment, wherein the at least one trade order segment corresponds to a tradeable object of the plurality of tradeable objects that has a financial product type and a financial product class indicated by the input selection, and wherein a radial width of the at least one trade order segment corresponds to the quantity of the tradeable object in an order book for a user; and
displaying, via the trading device, the trade order ring in response to the input selection.

13. The method of claim 9, wherein the relative size for each financial product type segment is indicated by a radial width of the financial product type segment.

14. The method of claim 9, wherein the relative size for each financial product class segment is indicated by a radial width of the financial product type segment.

15. The method of claim 9, further comprising:
receiving, via the trading device, an input selection of one of the displayed segments;
generating, via the trading device, at least one trade order that comprises an order quantity that is equal to the quantity of the tradeable objects represented by the segment corresponding to the input selection; and
sending, via the trading device, the at least one trade order to at least one of the one or more electronic exchanges.

16. A method for generating a multi-level position interface, the method comprising:
receiving, at a trading device, market data related to a plurality of tradeable objects offered at one or more electronic exchanges, wherein the market data indicates a market position of a user for each tradeable object of the plurality of tradeable objects;
assigning, at the trading device, different financial product classes and different financial product types related to the market position of the user for the plurality of tradeable objects;
displaying, via the trading device, a first level of the multi-level position interface that indicates the the market position of the user for the different financial product classes, wherein the first level includes a plurality of financial product class segments that each correspond to a financial product class, and wherein the market position of the user is indicated for each financial product class by a relative size of the financial product class segment that corresponds to the financial product class; and
displaying, via the trading device, a second level of the multi-level position interface that indicates the market position of the user for the different financial product types, wherein the second level includes a plurality of financial product type segments that each correspond to a financial product type, and wherein the market position of the user is indicated for each financial product type by a relative size of the financial product type segment that corresponds to the financial product type.

17. The method of claim 16, wherein the first level is displayed as a financial product class ring that includes the plurality of financial product class segments, and wherein the second level is displayed as a financial product type ring that includes the plurality of financial product type segments, and wherein the financial product class ring is encompassed by the financial product type ring.

18. The method of claim 16, further comprising:
generating, via the trading device, an order entry hub, wherein the order entry hub is configured for receiving order parameters via an input selection for generating trade orders to be submitted to at least one of the one or more electronic exchanges; and
displaying, via the trading device, the order entry hub.

19. The method of claim 16, wherein the relative size for each financial product type segment is indicated by a radial width of the financial product type segment, and wherein the relative size for each financial product class segment is indicated by a radial width of the financial product type segment.

20. The method of claim 16, further comprising:
receiving, via the trading device, an input selection of one of the displayed segments;
generating, via the trading device, at least one trade order that comprises an order quantity that is equal to the quantity of the tradeable objects represented by the segment corresponding to the input selection; and
sending, via the trading device, the at least one trade order to at least one of the one or more electronic exchanges.
